(19) United States
(12) Patent Application Publication
(10) Pub. No.: US 2026/0058551 A1
(43) Pub. Date: Feb. 26, 2026

(54) VOLTAGE CONVERSION CIRCUIT, SEMICONDUCTOR CIRCUIT, AND MOTOR DRIVE MODULE

(71) Applicants: Kabushiki Kaisha Toshiba, Tokyo (JP); Toshiba Electronic Devices & Storage Corporation, Tokyo (JP)

(72) Inventor: Tomohiro ANDO, Yokohama Kanagawa (JP)

(21) Appl. No.: 19/043,268

(22) Filed: Jan. 31, 2025

(30) Foreign Application Priority Data
Aug. 23, 2024 (JP) 2024-141759

(51) Int. Cl. H02M 3/07

(52) U.S. Cl. CPC H02M 3/07

(57) ABSTRACT

According to one embodiment, a voltage conversion circuit includes a current limit circuit having a first switch, a charge pump circuit having a first stage diode connected to the current limit circuit, and two or more subsequent stage diodes connected in series to each other and to the first stage diode, and a current supply circuit having a rectifier connected to a node between the subsequent stage diodes of the charge pump circuit, wherein a forward direction of the rectifier extends through the rectifier to the node.

### CROSS-REFERENCE TO RELATED APPLICATION(S)

This application is based upon and claims the benefit of priority from Japanese Patent Application No. 2024-141759, filed Aug. 23, 2024, the entire contents of which are incorporated herein by reference.

### FIELD

Embodiments described herein relate generally to a voltage conversion circuit, a semiconductor circuit, and a motor drive module.

### BACKGROUND

A charge pump-type voltage conversion circuit which converts an input voltage to an output voltage of a desired voltage is known. The charge pump-type voltage conversion circuit boosts the input voltage by switched capacitors.

### BRIEF DESCRIPTION OF THE DRAWINGS

FIG. 1 is a block diagram illustrating a voltage conversion circuit according to a first embodiment.

FIG. 2 is a diagram illustrating an example of a circuit configuration of the voltage conversion circuit according to the first embodiment.

FIG. 3 is a flowchart illustrating the operation of a current limit circuit and a current supply circuit in the voltage conversion circuit according to the first embodiment.

FIG. 4 is a block diagram illustrating a voltage conversion circuit according to a second embodiment.

FIG. 5 is a diagram illustrating an example of a circuit configuration of a voltage conversion circuit according to a third embodiment.

FIG. 6 is a circuit diagram illustrating a voltage conversion circuit according to a comparative example.

FIG. 7 is a flowchart illustrating the operation of the voltage conversion circuit according to the comparative example.

### DETAILED DESCRIPTION

Embodiments provide a voltage conversion circuit with improved reliability by reducing voltage fluctuations in a circuit.

In general, according to one embodiment, a voltage conversion circuit includes: a current limit circuit having a first switch; a charge pump circuit having a first stage diode connected to the current limit circuit, and two or more subsequent stage diodes connected in series to each other and to the first stage diode; and a current supply circuit having a rectifier connected to a node between the subsequent stage diodes of the charge pump circuit, wherein a forward direction of the rectifier extends through the rectifier to the node.

According to another embodiment, a voltage conversion circuit comprises: a charge pump circuit configured to convert an input voltage to an output voltage, and a current limit circuit configured to switch a connection state between the input voltage and the charge pump circuit, and a current supply circuit that is connected to the charge pump circuit, and configured to perform a rectification function between a power supply having the input voltage and the charge pump circuit, and to maintain a voltage in the charge pump circuit at or above Vcc−Vf, where Vcc is the input voltage and Vf is a forward voltage provided by the rectification function.

Each embodiment of the disclosure will be described below with reference to the drawings.

Furthermore, the drawings are schematic or conceptual, and the relationship between the thicknesses and widths of respective portions, the ratio of the sizes between the portions, and the like are not necessarily the same as the actual ones. In addition, even when representing the same portion, the dimensions and ratios of the portions may be represented differently depending on the drawings.

An electrode of a capacitor on the side connected to a diode in a charge pump circuit among the pair of opposite electrodes of the capacitor may be referred to herein as a first electrode. An electrode of the capacitor that is opposite to the first electrode and is connected to a switching circuit may be referred to herein as a second electrode. When a plurality of capacitors are provided, each of the plurality of capacitors has the first electrode and the second electrode.

In the present specification and each drawing, elements similar to those described above with reference to the previous drawings are given the same reference numerals and detailed descriptions thereof will be omitted as appropriate.

### First Embodiment

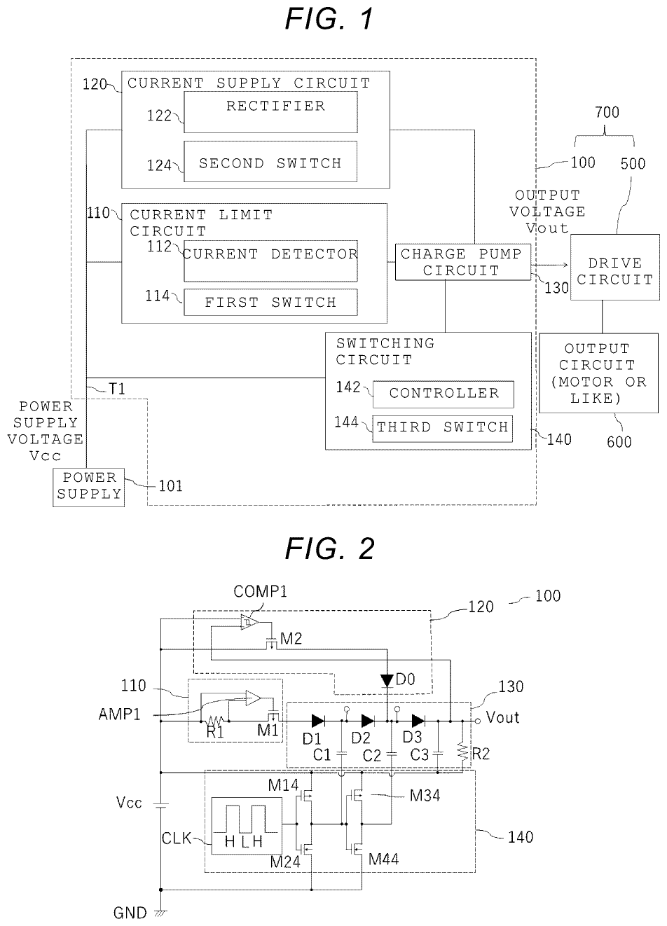

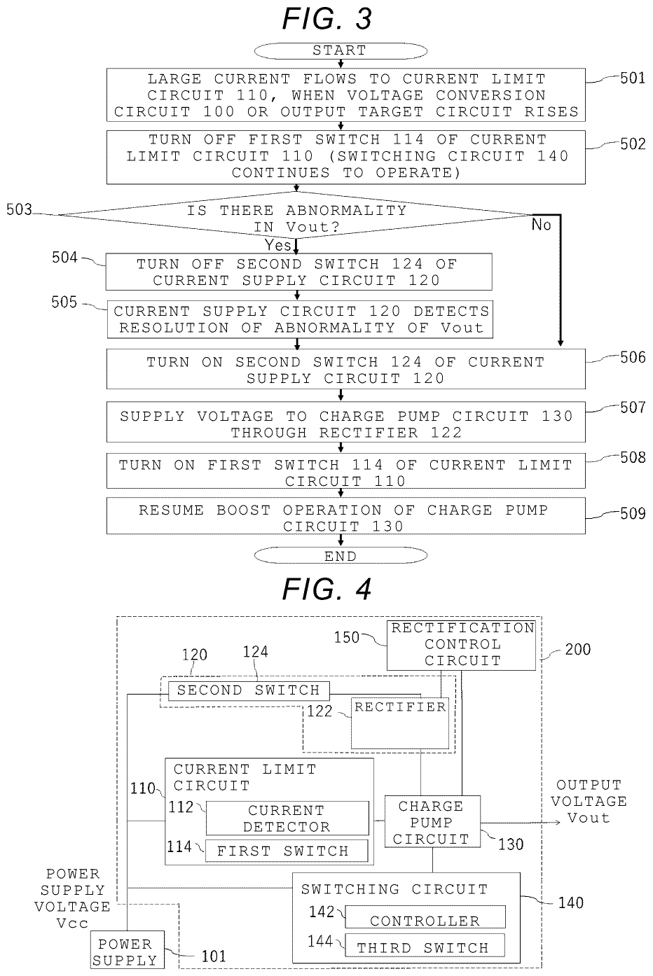

FIG. 1 is a block diagram of a voltage conversion circuit 100 according to a first embodiment. FIG. 2 illustrates an example of a circuit configuration of the voltage conversion circuit 100 according to the first embodiment. FIG. 3 is a flowchart illustrating an example of operation of the voltage conversion circuit 100 according to the first embodiment.

As illustrated in FIG. 1, the voltage conversion circuit 100 of the present embodiment includes a current limit circuit 110 connected to a power supply voltage Vcc, which is an input voltage, a current supply circuit 120 connected to the power supply voltage Vcc, and a charge pump circuit 130 connected to the current limit circuit 110 and the current supply circuit 120. The power supply voltage Vcc is a voltage output from a power supply 101, for example, a battery, and the voltage conversion circuit 100 has a terminal T1 to which the power supply voltage Vcc is input. The charge pump circuit 130 outputs an output voltage Vout. A switching circuit 140 is connected between the power supply voltage Vcc and the charge pump circuit 130. The current supply circuit 120 and the current limit circuit 110 are connected to the same power supply voltage Vcc, for example, but not limited thereto. For example, although a power supply that supplies a voltage to the current supply circuit 120 may be further provided, it is desirable that the voltage to be supplied to the current supply circuit 120 be a voltage equal to the power supply voltage Vcc.

In addition, the output voltage Vout of the voltage conversion circuit 100 is connected to a drive circuit 500. The drive circuit 500 is a motor drive circuit for driving a motor, for example. The drive circuit 500 is driven by the output voltage Vout converted by the voltage conversion circuit 100. The drive circuit 500 drives an output circuit 600. The output circuit 600 is, for example, a motor. The voltage conversion circuit 100 and the drive circuit 500 are collectively referred to as a power supply circuit (or more generally, a semiconductor circuit) 700. The power supply circuit 700 supplies power for operating a motor, for example. The power supply circuit 700 is connected to the power supply 101, performs voltage conversion, and drives the output circuit 600. The power supply circuit 700 is a motor drive module for driving a motor, for example.

The current limit circuit 110 includes a current detector 112 and a first switch 114. When the current detector 112 detects a current larger than a predetermined magnitude, the current limit circuit 110 turns off the first switch 114 to release the conductive state between the power supply voltage Vcc and the charge pump circuit 130. Examples of the method of returning the first switch 114 to the on state include a method of automatically returning to the on state after a certain period of time. Here, the method of automatically returning to the on state after a certain period of time is based on, for example, receiving the input of a clock and measuring a certain period of time. It should be noted that the clock may be the clock of a clock input CLK in the switching circuit 140 in FIG. 2, which will be described later, or may be a clock input from outside the voltage conversion circuit 100. Further, a method of returning to the on state when the current value detected by the current detector 112 falls below a predetermined value may be used.

The current supply circuit 120 includes a rectifier 122. The current supply circuit 120 further includes a second switch 124. When the second switch 124 is in the on state, the power supply voltage Vcc and the charge pump circuit 130 are connected via the rectifier 122. The forward direction of the rectifier 122 is the direction from the current supply circuit 120 to the charge pump circuit 130. The current supply circuit 120 has a rectification function.

Although not illustrated in FIG. 1, the current supply circuit 120 may further be provided with a voltage detection circuit for circuit protection when a ground fault or the like occurs in the drive circuit 500 or the output circuit 600. The voltage detection circuit outputs a predetermined voltage according to the input voltage. The voltage detection circuit is, for example, a voltage comparison circuit. The voltage comparison circuit compares the voltages at two predetermined points (described later) and provides a path for the current flowing from the power supply voltage Vcc to the charge pump circuit 130 via the rectifier 122 with the second switch 124 in the on state under a predetermined condition (described later).

The charge pump circuit 130 includes a plurality of diodes connected in series. The charge pump circuit 130 is, for example, an asynchronous charge pump circuit. The charge pump circuit 130 further has a plurality of capacitors. The voltage of the capacitor is controlled by the switching circuit 140. The connection state between the capacitor and the power supply voltage Vcc, which is the input voltage, is switched periodically by the switching circuit 140. By switching the connection state of the capacitor, the charge pump circuit 130 converts the power supply voltage Vcc to the output voltage Vout. The number of capacitors that the charge pump circuit 130 has, that is, the number of stages of the charge pump circuit 130, is any integer greater than or equal to 3.

The switching circuit 140 supplies the charge pump circuit 130 with a voltage that varies over time between a high voltage and a low voltage. The switching circuit 140 includes a third switch 144, and a controller 142 that periodically transitions the third switch 144 to the on or off state. The controller 142 inputs a signal for the operation of switching to the third switch 144 in a constant manner. The term “constant manner” here means that the operation continues regardless of the internal state of the voltage conversion circuit 100. Here, the internal state of the voltage conversion circuit 100 includes, for example, the on/off state of the first switch 114. The controller 142 inputs a clock to the third switch 144, for example.

When the first switch 114 of the current limit circuit 110 is in the off state, the power supply voltage Vcc is not supplied to the charge pump circuit 130, and no boost is performed. On the other hand, the switching circuit 140 does not stop operation, and switching of the connection state of the third switch 144 of the switching circuit 140 is performed. This is because the boost operation by the charge pump circuit 130 can be resumed quickly, when the first switch 114 of the current limit circuit 110 returns to the on state. The current supply circuit 120 supplies a predetermined voltage from the power supply voltage Vcc to the charge pump circuit 130 via a rectifier element D0 when the second switch 124 is in the on state.

Next, a description will be made with reference to FIG. 2. FIG. 2 illustrates an example of a circuit configuration.

The current limit circuit 110 includes a first resistor R1, a first amplifier AMP1, and a first transistor M1. The first amplifier AMP1 amplifies the voltage drop across the first resistor R1, and detects the current flowing through the first resistor R1 from the known resistance value of the first resistor R1.

The first resistor R1 and the first amplifier AMP1 are examples of the current detector 112. The first transistor M1 is an example of the first switch 114 of the current limit circuit 110, and is turned off when the current flowing through the first resistor R1 is greater than a predetermined magnitude. The first transistor M1 is, for example, a MOSFET. The first transistor M1 is, for example, a p-channel type MOSFET and is turned off when the gate voltage is larger than a predetermined threshold voltage. The output of the first amplifier AMP1 is connected to a gate electrode of a MOSFET, for example.

When the voltage that the first amplifier AMP1 amplifies and outputs the voltage drop across the first resistor R1 is greater than the threshold voltage at which the first transistor M1 is turned off, the current limit circuit 110 cuts off the current flowing from the power supply voltage Vcc to the charge pump circuit 130.

The current supply circuit 120 includes the rectifier element D0. The rectifier element D0 is an example of the rectifier 122. The current supply circuit 120 may further include a first comparator COMP1 and a second transistor M2. The second transistor M2 is an example of a second switch 124 of the current supply circuit 120. The first comparator COMP1 is an example of a voltage detection circuit that detects an output voltage Vout. The voltage detection circuit includes at least the output voltage Vout as an input. The first comparator COMP1 is a voltage comparison circuit that detects the magnitude of the output voltage Vout by comparing the power supply voltage Vcc and the output voltage Vout.

The first comparator COMP1 compares the power supply voltage Vcc and the output voltage Vout, and switches on and off of the second transistor M2. For example, the first comparator COMP1 turns off the second transistor M2 when Vout<Vcc, and turns on the second transistor M2 when Vout≥Vcc. For example, the second transistor M2 is a p-channel type MOSFET, and the first comparator COMP1 outputs a voltage greater than the threshold voltage of the second transistor M2 when Vout<Vcc, and outputs a voltage smaller than the threshold voltage of the second transistor M2 when Vout≤Vcc.

It should be noted that the first transistor M1 and the second transistor M2 may be n-channel type MOSFETs, and the positive/negative polarity and offset of the output signal of the first amplifier AMP1 and the first comparator COMP1 may be adjusted as appropriate.

The rectifier element D0 has a rectification function in the forward direction which is the direction from the current supply circuit 120 to the charge pump circuit 130. The rectifier element D0 is, for example, a diode. The forward voltage Vf0 of the rectifier element D0 is preferably equal to the forward voltage Vf of the diodes D1, D2, and D3 of the charge pump circuit 130, which will be described later. The rectifier element D0 may be a diode whose forward voltage is less than Vf, or a diode whose forward voltage is greater than Vf. Instead of diodes, a MOSFET or thyristor may be used as the rectifier element D0.

The charge pump circuit 130 includes a plurality of diodes D1, D2, and D3 connected in series, a first capacitor C1 connected to the cathode of the first diode D1, a second capacitor C2 connected to the cathode of the second diode D2, and a third capacitor C3 connected to the cathode of the third diode D3. The charge pump circuit 130 further includes a second resistor R2 connected in parallel with the third capacitor C3. The first diode D1, the second diode D2, and the third diode D3 each have an equal forward voltage Vf.

As the method of counting the number of stages of the plurality of diodes provided, the diodes are called a first stage, a second stage, and a third stage diodes, or first stage and subsequent stage diodes, or the like in the direction from the power supply voltage Vcc to the output voltage Vout. That is, the number of steps is counted in the direction in which the voltage is boosted. The first diode D1 is also called a first stage diode. In addition, a plurality of diodes connected to the first stage diodes, including diodes D2 and D3, are referred to as subsequent stage diodes. The rectifier element D0 is connected to a node between the subsequent stage diodes. In other words, the rectifier element D0 is connected to at least one connection points between the subsequent stage diodes. When the second transistor M2 of the current supply circuit 120 is in the on state, the voltage drop at at least one connection points between the subsequent stage diodes is kept equal to or less than the forward voltage Vf0 of the rectifier element D0 on the basis of the power supply voltage Vcc.

A time-varying voltage is applied to the second electrodes of the first capacitor C1 and the second capacitor C2 on the switching circuit 140 side, respectively. The voltage is controlled such that the high voltage and the low voltage are repeated periodically by the switching circuit 140 described below. The voltages of the second electrodes of the first capacitor C1 and the second capacitor C2 are periodically switched between the power supply voltage Vcc and the ground voltage GND, respectively, for example. The power supply voltage Vcc is applied to the second electrode of the third capacitor C3.

The charge pump circuit 130 includes the second resistor R2 connected in parallel with the third capacitor C3. The voltages at ends of the second resistor R2 are the power supply voltage Vcc and the output voltage Vout, respectively. When the first transistor M1 of the current limit circuit 110 is in the off state and the boost operation is paused, the output voltage Vout is kept equal to the power supply voltage Vcc via the second resistor R2.

The switching circuit 140 includes a clock input CLK and transistors M14, M24, M34, M44. The clock input CLK is an example of the controller 142, and the transistors M14, M24, M34, and M44 are an example of the third switch 144. The clock signal may be generated outside the switching circuit 140, and the switching circuit 140 may further be provided with a clock generator. The clock input CLK inputs clock signals to the transistors M14, M24, M34, and M44 and performs switching periodically. The transistors M14, M24, M34, and M44 are, for example, MOSFETs. The transistors M14 and M34 are, for example, p-channel type MOSFETS, and the transistors M24 and M44 are, for example, n-channel type MOSFETS.

An example of operations of the charge pump circuit 130 and the switching circuit 140 will be described.

When the clock by the clock input CLK of the switching circuit is in a low (L) state, the transistor M14 is turned on and the transistor M24 is turned off. The second electrode of the first capacitor C1 on the switching circuit 140 side is connected to the power supply voltage Vcc. In addition, the power supply voltage Vcc is connected to gate electrodes of the transistors M34 and M44, and the transistor M34 is turned off and the transistor M44 is turned on. The second electrode of the second capacitor C2 is grounded via the transistor M44.

On the other hand, when the clock is in a high (H) state, the transistor M14 is turned off and the transistor M24 is turned on. The first electrode of the first capacitor C1 on the switching circuit 140 is grounded. In addition, the gate electrodes of the transistors M34 and M44 are grounded, the transistor M34 is turned on, and the transistor M44 is turned off. The second electrode of the second capacitor C2 is connected to the power supply voltage Vcc via the transistor M34.

When the clock is in the H state, the second electrode of the first capacitor C1 is grounded, and the first electrode is at a voltage of Vcc−Vf, which is obtained by subtracting the forward voltage Vf of the first diode D1 from the power supply voltage Vcc. That is, the first capacitor C1 stores charges corresponding to the voltage difference Vcc−Vf. Here, when the clock transitions to the L state, the voltage of the second electrode of the first capacitor C1 becomes Vcc, and the voltage of the first electrode becomes 2Vcc−Vf due to the charges stored in the first capacitor C1 when the clock is in the H state. Then, when the clock is in the L state, the second electrode of the second capacitor C2 is grounded, and the first electrode of the second capacitor C2 becomes a voltage of 2Vcc−2Vf which is obtained by subtracting the forward voltage of the second diode D2 from 2Vcc−Vf. The second capacitor C2 stores charges corresponding to the voltage difference 2Vcc−2Vf.

Thus, by repeatedly inputting H and L of the clock, the voltage across the first capacitor C1 becomes Vcc−Vf, while the voltage across the second capacitor C2 becomes 2Vcc−2Vf. The voltage across the third capacitor C3 is 2Vcc−3Vf, in consideration of the forward voltage Vf of the third diode D3, and the output voltage Vout is boosted to 3Vcc−3Vf=3(Vcc−Vf). Thus, the boosted voltage is output as the output voltage Vout.

FIG. 3 is a flowchart illustrating an example of operation of the voltage conversion circuit 100 according to the present embodiment.

In step 501 of FIG. 3, a situation is considered as an example in which a large current flows to the current limit circuit 110, when the voltage conversion circuit 100 starts up. Specifically, a large current flows through the first resistor R1 in the example illustrated in FIG. 2. When the voltage conversion circuit 100 is not performing a boost operation and the first capacitor C1 is not storing a charge, that is, when the voltage conversion circuit 100 starts up, the voltage across the first resistor R1 becomes large and there is a risk that a large current may flow.

Next, in step 502, when the value of current flowing through the current limit circuit 110 becomes larger than a predetermined value, the current detector 112 illustrated in FIG. 1 turns off the first switch 114. In the example of FIG. 2, the gate voltage of the first transistor M1 increases via the first amplifier AMP1 due to the large voltage across the first resistor R1, and, for example, the transistor M1, which is a p-channel type MOSFET, is turned off.

Subsequently, since the operation changes in accordance with whether there is an abnormality in the output voltage Vout after step 503, it is determined whether there is an abnormality in the output voltage Vout. For example, the current supply circuit 120 detects the output voltage Vout. The output voltage Vout is maintained at or above Vcc while the voltage conversion circuit 100 is performing a normal boost operation. Further, when the voltage conversion circuit 100 is not performing the boost operation, the output voltage Vout is maintained at, for example, Vout=Vcc via the second resistor R2.

Therefore, it is possible to determine whether the output voltage Vout is abnormal by comparing Vout and Vcc by the first comparator COMP1 of the current supply circuit 120. For example, the determination may be based on whether or not Vout<Vcc is satisfied. It is not limited to Vout<Vcc, but may be set to Vout<Vcc−Vm in consideration of a predetermined margin Vm (≥0).

Examples of the situation of Vout<Vcc include a case where a short circuit occurs in the drive circuit 500 or the output circuit 600 to which the output voltage Vout is supplied. The output voltage Vout may be short-circuited to the ground voltage GND. It should be noted that when the output voltage Vout is determined to be abnormal in step 503, the cause of the large current flowing to the current limit circuit 110 in step 501 is considered to be an abnormality of the output voltage Vout.

First, the case where the output voltage Vout is determined to be abnormal in step 503 will be described. In the following step 504, the second switch 124 (second transistor M2 in FIG. 2) of the current supply circuit 120 is turned off. In the example illustrated in FIG. 2, when the first comparator COMP1 determines that the output voltage Vout is abnormal in step 503, the gate voltage of the second transistor M2 is controlled to turn off the second transistor M2.

By turning off the second switch 124 of the current supply circuit 120, the conductive state between the power supply voltage Vcc and the charge pump circuit 130 via the current supply circuit 120 is released. Therefore, the flow of current from the power supply voltage Vcc to the charge pump circuit 130 via the current supply circuit 120 is reduced. Since it is determined that there is an abnormality in Vout in step 503, when a path of current from the power supply voltage Vcc to the charge pump circuit 130 is present, there is a risk that a large current flows through the rectifier element D0 of the current supply circuit 120 to overheat and break down the rectifier element D0. In step 504, by turning off the second switch 124, the breakdown of the rectifier element D0 of the current supply circuit 120 is prevented.

Subsequently, in step 505, the abnormality of the output voltage Vout is resolved, and the current supply circuit 120 detects the resolution of the abnormality. The resolution of the abnormality of the Vout is performed by solving a problem such as a short circuit of the drive circuit 500 and the output circuit 600. Then, the first comparator COMP1 of the current supply circuit 120 detects that the abnormality of the output voltage Vout has been resolved by comparing the output voltage Vout to the power supply voltage Vcc. After the abnormality of the Vout is resolved in step 505, the state returns to the normal state, for example, Vout=Vcc. Then, the process proceeds to the next step 506.

On the other hand, when the current supply circuit 120 does not detect an abnormality in Vout in step 503, the process proceeds to step 506.

In step 506, the second switch 124 (second transistor M2 in FIG. 2) of the current supply circuit 120 is turned on. First, when the process proceeds from step 505 to 506, Vout=Vcc, so that the voltage comparison circuit (for example, the comparator COMP1) of the current supply circuit 120 turns on the second switch 124 (for example, the second transistor M2). In addition, when the process jumps from step 503 to 506, the second switch 124 of the current supply circuit 120 is maintained in the on state (including maintaining the on state, it is described that the second switch 124 is turned on in step 506 of FIG. 3). Thus, the power supply voltage Vcc and the charge pump circuit 130 are electrically connected via the current supply circuit 120.

In step 507, a voltage is supplied from the power supply voltage Vcc to the charge pump circuit 130 via the rectifier 122 of the current supply circuit 120. In the example illustrated in FIG. 2, a voltage of Vcc−Vf0 is supplied to the cathode of the second diode D2 and the first electrode of the second capacitor C2 of the charge pump circuit 130 via the rectifier element D0 (a diode with a forward voltage Vf0).

The supply of voltage to the cathode of the second diode D2 prevents a decrease in the voltage of the cathode of the second diode D2 relative to the cathode of the first diode D1.

Subsequently, in step 508, the current detector 112 of the current limit circuit 110 turns on the first switch 114 (the first transistor M1 of FIG. 2). That is, the current limit circuit 110 returns to the on state. The current limit circuit 110 is, for example, set to automatically return to the on state after a certain period of time has elapsed since the first switch 114 of the current limit circuit 110 is turned off in step 502. Alternatively, the first switch 114 may be turned on when the magnitude of the current flowing through the current limit circuit 110 falls below a predetermined value. The first transistor M1 can be turned on by detecting the magnitude of the current flowing through the first resistor R1 by the first amplifier AMP1 of the current detector 112.

In step 508, after a reduction of a risk that a large current flows through the charge pump circuit 130 to break down the diodes D1 to D3, the current limit circuit 110 turns on. Further, the switching circuit 140 continues to operate in step 508.

Therefore, in the next step 509, the charge pump circuit 130 resumes the boost operation because the current limit circuit 110 is in the on state. The voltage obtained by boosting the power supply voltage Vcc is output as the output voltage Vout.

As illustrated above in steps 501 to 509, a voltage is supplied to the charge pump circuit 130 via the current supply circuit 120 during the period until the boost operation is resumed after a large current flows via the current limit circuit 110.

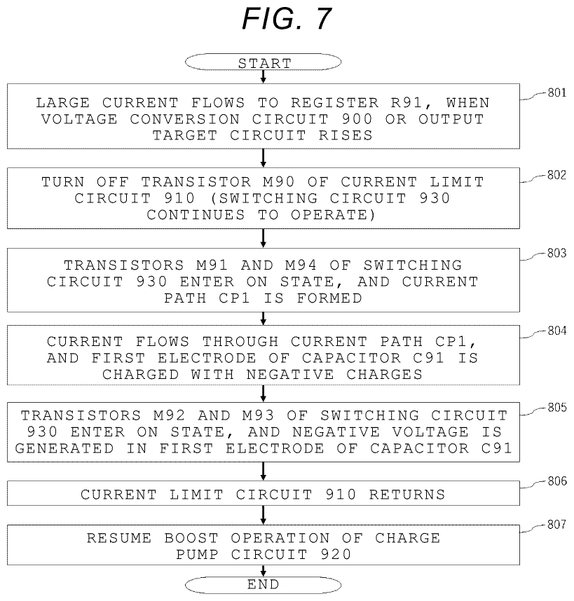

Next, with reference to FIGS. 6 and 7, a voltage conversion circuit 900 according to the comparative example will be described. FIG. 6 is a diagram illustrating an example of a circuit configuration of the voltage conversion circuit 900. FIG. 7 is a flowchart illustrating an example of the operation of the voltage conversion circuit 900.

As illustrated in FIG. 6, the voltage conversion circuit 900 includes a power supply voltage Vcc, a current limit circuit 910, a charge pump circuit 920, and a switching circuit 930.

The current limit circuit 910 includes a resistor R91, an amplifier AMP91, and a transistor M90. When the value of the current flowing through the resistor R91 exceeds a predetermined magnitude, the transistor M90 turns off and releases the conductive state between the power supply voltage Vcc and the charge pump circuit 920.

The charge pump circuit 920 includes a plurality of diodes D91, D92, and D93, a plurality of capacitors C91, C92, and C93, and a resistor R92. The voltages of the second electrodes of the capacitors C91, C92, and C93 of the charge pump circuit 920 on the switching circuit 930 side are controlled by the switching circuit 930. The voltages of the second electrodes of the capacitors C91 and C92 are periodically switched between the power supply voltage Vcc and the ground voltage GND. The voltage of the second electrode of the capacitor C93 is maintained at the power supply voltage Vcc, and the resistor R92 is connected in parallel with the capacitor C93.

The switching circuit 930 includes a clock input CLK and transistors M91, M92, M93, M94. The switching circuit 930 transitions between a state in which the transistors M91 and M94 are in the on state and the transistors M92 and M93 are in the off state and a state in which the transistors M91 and M94 are in the off state and the transistors M92 and M93 are in the on state.

The boost operation by the charge pump circuit 920 and the switching circuit 930 is omitted because it is not significantly different from the voltage conversion circuit 100 according to the first embodiment.

Referring to FIG. 7, the operation of the voltage conversion circuit 900 according to the comparative example will be described. First, as illustrated in step 801, a large current flows momentarily through the resistor R91 of the current limit circuit 910 when the voltage conversion circuit starts up, or the like.

Therefore, in the following step 802, the transistor M90 is turned off and no boosting is performed by the charge pump circuit 920. On the other hand, the operation of the switching circuit 930 is not stopped because the clock input CLK continues to operate such that the boost operation can be immediately resumed when the current limit circuit 910 returns to the conductive state.

As the switching circuit 930 continues to operate, the transistors M91 and M94 are then turned on and the transistors M92 and M93 are turned off, as illustrated in step 803. Thus, a current path CP1 illustrated in FIG. 6 is formed.

The current path CP1 is a path from the power supply voltage Vcc through the transistor M91, the capacitor C91, the diode D92, the capacitor C92, and the transistor M94 to reach the ground voltage GND. The current flows through the current path CP1 when the voltage across the diode D92 is greater than the forward voltage Vf.

For example, in a state where no charge is stored in the capacitor C91 (before performing the boost operation by the charge pump circuit 920), when the voltage of the anode of the diode D92 is the power supply voltage Vcc, and the voltage of the cathode of the diode D92 is less than Vcc−Vf, a current can flow through the current path CP1.

Next, as illustrated in step 804, a current flows through the current path CP1, and the second electrode of the capacitor C91 is positively charged, while the first electrode is negatively charged. The voltage of the second electrode of the capacitor C91 becomes higher than the first electrode.

When the switching circuit 930 performs the switching operation in the following step 805, the transistors M91 and M94 are turned off and the transistors M92 and M93 are turned on. The second electrode of the capacitor C91 is grounded. Since a negative charge is charged in the first electrode of the capacitor C91, the first electrode of the capacitor C91 has a negative voltage. Thus, there is a risk of causing a negative voltage inside the charge pump circuit 920.

The current limit circuit 910 and the charge pump circuit 920 are formed on the same chip, for example, and there is a risk that a parasitic transistor or a parasitic thyristor in the chip may be turned on when a negative voltage is generated inside the charge pump circuit 920. This may cause a fault due to a short circuit and impair the reliability of the voltage conversion circuit.

In the following step 806, the current limit circuit 910 returns to the on state. The circuit may be set to automatically return to the on state after a certain period of time, or may return to the on state when the value of the current flowing through the resistor R91 becomes smaller than a predetermined value.

In step 807, the boost operation of the charge pump circuit 920 is resumed when the current limit circuit 910 returns to the on state. The switching operation of the switching circuit 930 continues uninterrupted until the current limit circuit 910 returns to the on state, and the boost operation by switching resumes when the current limit circuit 910 returns to the on state.

As described with reference to FIG. 7, in the voltage conversion circuit 900 according to the comparative example, while the current limit circuit 910 is turned off to prevent a large current from flowing through the charge pump circuit 920, when switching occurs, the capacitor C91 is charged, and there is a risk that a negative voltage may be generated inside the charge pump circuit 920. It is not possible to achieve both quick resumption of the boost operation without stopping the operation of the switching circuit 930 and reliability of the voltage conversion circuit. The voltage conversion circuit 900 according to the comparative example has been described above.

With the voltage conversion circuit 100 according to the present embodiment, the reliability of the voltage conversion circuit can be improved by reducing voltage fluctuations in the charge pump circuit 130, specifically reducing the generation of a negative voltage. On the other hand, by not stopping the operation of the switching circuit 140, the boost operation can be quickly resumed.

Reducing the generation of a negative voltage will be described again with reference to FIG. 2. FIG. 2 illustrates an example of a configuration for preventing the first electrode of the first capacitor C1 from being negatively charged and generating a negative voltage.

A state is considered in which the first transistor M1 of the current limit circuit 110 is turned off. Since the cathode of the second diode D2 is connected to the power supply voltage Vcc via the rectifier element D0 (forward voltage is Vf0) of the current supply circuit 120, the voltage of the cathode of the second diode D2 is maintained at or above at least Vcc−Vf0.

Since the second diode D2 flows current in the forward direction when a voltage difference greater than Vf occurs in the forward direction, a current flows in the second diode D2 when the voltage of the anode of the second diode D2 is at least Vcc−Vf0+Vf or higher. For example, when Vf0≤Vf, it is Vcc−Vf0+Vf≥Vcc, and positive charges corresponding to the voltage difference Vf−Vf0 (≥0) are stored (or no charge is stored) in the first electrode of the first capacitor C1. That is, even when a current flows through the second diode D2, a negative charge is not stored in the first electrode of the first capacitor C1. Even when the switching circuit 140 operates and the voltage of the second electrode of the first capacitor C1 is switched from, for example, the power supply voltage Vcc to the ground voltage GND, the voltage of the first electrode of the first capacitor C1 is not negative.

With the voltage conversion circuit 100 according to the present embodiment, the amount of charges stored in the first capacitor can be controlled by the forward voltage Vf0 of the rectifier element D0 while the first switch 114 in the current limit circuit 110 is in the off state. For example, when Vf0≤Vf, the voltage of the first electrode of the first capacitor C1 becomes positive with respect to the second electrode or the same voltage as the second electrode, and no negative voltage is generated even when the switching circuit 140 performs a switching operation and the second electrode of the first capacitor C1 is grounded. In other words, by setting Vf0≤Vf, it is possible to prevent the generation of a negative voltage in the charge pump circuit 130.

When Vf0=Vf, when the voltage of the second electrode of the first capacitor C1 is connected to, for example, the power supply voltage Vcc, the voltage of the first electrode of the first capacitor C1 is ideally zero with respect to the second electrode, a current is prevented from flowing through the second diode D2, and negative charge is prevented from being charged in the first electrode of the first capacitor C1.

Furthermore, if Vf0=Vf, the amount of current flowing to prevent generation of negative voltage through the rectifier element D0 is reduced compared to when Vf0<Vf, thereby preventing the conduction loss of the rectifier element D0. If Vf0=Vf, a current flows through the rectifier element D0 such that the cathode voltage of the second diode D2 is not less than Vcc−Vf. On the other hand, in the case of Vf0<Vf, when the cathode voltage of the second diode D2 becomes less than Vcc−Vf0 (>Vcc−Vf), a current flows through the rectifier element D0. The range of the cathode voltage of the second diode D2 where a current flows is wider when Vf0<Vf than when Vf0=Vf. Both of these prevent the generation of a negative voltage at the first electrode of the first capacitor C1, but the amount of current flowing through the rectifier element D0 is smaller if Vf0=Vf.

In other words, if Vf0≤Vf, the generation of the negative voltage can be prevented. However, if Vf0=Vf, the conduction loss can be prevented by optimizing the condition in which a current flows through the rectifier element D0 to reduce the amount of current necessary to prevent the generation of the negative voltage flow. In order to prevent the loss, it is desirable that Vf0=Vf. For example, the rectifier element D0 is preferably the diode with the same rectification properties as the second diode D2.

Even if Vf0>Vf, the magnitude of the negative voltage generated can be reduced and reliability can be improved while the first switch 114 in the current limit circuit 110 is in the off state. The loss of a positive charge (or the charge of a negative charge) from the first electrode of the first capacitor C1 occurs when charges move by the current flowing through the second diode D2, but the cathode voltage of the second diode D2 is maintained at or above Vcc−Vf0. Therefore, while the anode voltage of the second diode D2 is Vcc−Vf0+Vf or higher, a positive charge is lost from (or a negative charge is charged in) the first electrode of the first capacitor C1, and the value of Vf0 can be selected appropriately to control the amount of charges stored in the first electrode of the first capacitor C1. If Vf0>Vf, the voltage of the first electrode of the first capacitor C1 can also be negative voltage, but the magnitude of the negative voltage generated can be controlled by selecting the value of Vf0 appropriately. For example, the absolute value of the generated negative voltage can be reduced, compared to the voltage conversion circuit 900 according to the comparative example.

Further, if Vf0>Vf, no current flows through the rectifier element D0 until the cathode voltage of the second diode D2 is less than Vcc−Vf0 (<Vcc−Vf). Therefore, compared to when Vf0≤Vf, it is possible to reduce the current flowing through the rectifier element D0 and further reduce the conduction loss.

As described above, with the voltage conversion circuit 100 according to the present embodiment, the negative voltage generated inside the charge pump circuit 130 can be reduced by the rectifier 122 provided in the current supply circuit 120. In the voltage conversion circuit 100 according to the present embodiment, by selecting the forward voltage Vf0 of the rectifier element D0 as appropriate, it is possible to control the negative voltage generated while the first switch 114 in the current limit circuit 110 is in the off state. The value of Vf0 is desired to satisfy Vf0≤Vf in order to prevent the generation of negative voltage. Furthermore, loss can be further reduced by setting Vf0=Vf. On the other hand, when Vf0>Vf, the magnitude of the negative voltage generated can be reduced, and the current flowing through the rectifier element D0 can be reduced to reduce the loss.

Furthermore, with the voltage conversion circuit 100 according to the present embodiment, it is possible to prevent breakdown of the rectifier element D0 and the diodes D1, D2, and D3 of the charge pump circuit 130, and further enhance the reliability of the circuit, by turning off the second switch 124 of the current supply circuit 120, when an abnormality occurs in the output voltage Vout.

The first comparator COMP1 of the current supply circuit 120 turns off the transistor M2, which is an example of the second switch 124, for example, if Vout<Vcc, so that no current flows through the rectifier element D0. It is possible to prevent a large current from flowing through the rectifier element D0 to break down the rectifier element D0, when an output voltage Vout is short-circuited to GND, etc.

In the above description, examples of the first comparator COMP1 and the second transistor have been described as the second switch 124 of the current supply circuit 120. However, a current detection circuit may be used instead of the first comparator COMP1 to control the on and off of the second transistor M2 of the current supply circuit 120. The current detection circuit includes, for example, a resistor and an amplifier, and turns off the second transistor M2 when a current of a predetermined magnitude or greater flows. It is also possible to prevent a large current from flowing through the rectifier element D0 with a configuration having the current detection circuit.

### Second Embodiment

FIG. 4 is a diagram illustrating an example of a circuit configuration of a voltage conversion circuit 200 according to a second embodiment. Those common to the voltage conversion circuit 100 according to the first embodiment illustrated in FIG. 2 will not be described.

In the voltage conversion circuit 200 according to the present embodiment, the current supply circuit 120 has a rectifier 122, and the forward voltage Vf0 of the rectifier 122 is variable. The rectifier 122 has the forward direction from the power supply voltage Vcc to the charge pump circuit 130, and includes, for example, a MOSFET or a thyristor. The rectifier 122 has a gate electrode, and can adjust the forward voltage Vf0 depending on the voltage applied to the gate electrode. For example, the forward voltage Vf0 of the rectifier 122 can be varied depending on the voltage applied to a gate electrode of the thyristor.

The voltage conversion circuit 200 according to the present embodiment further includes a rectification control circuit 150. The rectification control circuit 150 is connected to the gate electrode of the rectifier 122, and controls the magnitude of the forward voltage Vf0 of the rectifier 122.

The rectification control circuit 150 is further connected to the charge pump circuit 130. The rectification control circuit 150 may control the rectifier 122 based on characteristics such as, for example, the forward voltages of diodes (such as diodes D1 to D3 in FIG. 2) inside the charge pump circuit 130. Specifically, when the forward voltage of the diodes inside the charge pump circuit 130 increases (decreases), for example, due to aging, the forward voltage of the rectifier 122 may be increased (decreased).

Alternatively, the rectification control circuit 150 may be connected to a portion that outputs an output voltage Vout, for example, inside the charge pump circuit 130. By detecting an abnormality of the output voltage Vout, the forward voltage Vf0 of the rectifier 122 can be adjusted. For example, when an abnormality of the output voltage Vout is detected, the forward voltage Vf0 of the rectifier 122 is increased to prevent the flow of current through the rectifier 122.

Although not illustrated in FIG. 4, the current supply circuit 120 may be provided with a first comparator COMP1 and a second resistor R2 illustrated in FIG. 2 to be connected to the second switch 124. The overheat and breakdown of the rectifier 122 can be reduced, and the reliability of the voltage conversion circuit 200 can be further improved.

In the voltage conversion circuit 200 according to the present embodiment, the rectifier 122 has a variable forward voltage Vf0, so that Vf0 can be determined to an appropriate desirable value while taking into consideration the prevention of the generation of negative voltage in the charge pump circuit 130 and the reduction of loss of the current flowing through the rectifier element D0.

As described in the first embodiment, when Vf0<Vf, it is possible to prevent a negative voltage from being generated in the charge pump circuit 130, while the current flowing through the rectifier element D0 may increase. On the other hand, when Vf0>Vf, the current flowing through the rectifier element D0 becomes smaller, and a negative voltage may be generated.

The magnitude of the allowable negative voltage or the like varies depending on the characteristics of the circuit, and the optimum value of Vf0 may also vary. For example, although Vf=Vf0 is desirable, Vf=Vf0 is not necessarily always optimal. By controlling the forward voltage Vf0 by the rectification control circuit 150, the value of Vf0 can be optimized. Compared to when many types of diodes are provided, an efficient and optimal current supply circuit 120 can be provided.

Furthermore, even when the voltage conversion circuit 200 is in operation, the forward voltage Vf0 can be changed thereafter. Therefore, the optimum Vf0, which can vary depending on the operating environment of the voltage conversion circuit 200, is set, and the magnitude of the negative voltage can be controlled and the loss can be reduced.

Third Embodiment

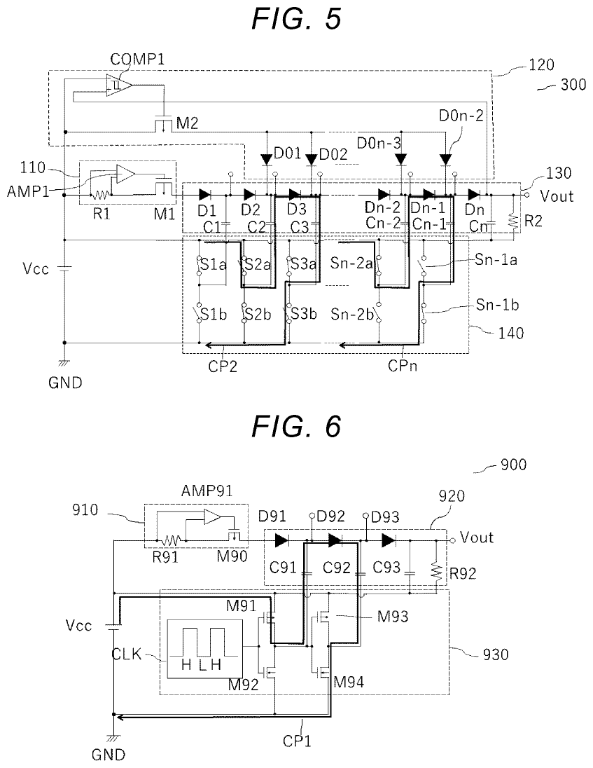

FIG. 5 is a diagram illustrating an example of a circuit configuration of a voltage conversion circuit 300 according to a third embodiment. Those common to the voltage conversion circuit 100 according to the first embodiment illustrated in FIG. 2 will not be described.

In the voltage conversion circuit 300 according to the present embodiment, the charge pump circuit 130 has n diodes and n capacitors. The plurality of diodes, that is, the first diode D1 to the n-th diode Dn are connected in series. n capacitors C1 to Cn are connected between the respective cathodes of the n diodes and the switching circuit 140.

The first diode D1 to the n-th diode Dn have, for example, a forward voltage Vf.

The current supply circuit 120 includes n-2 rectifier elements D01, D02, . . . , and D0n-2. n-2 rectifier elements do not need to be the same. The current supply circuit 120 is connected between the power supply voltage Vcc and the n-1 diodes (the subsequent stage diodes) of the charge pump circuit 130 except for the first diode (the first stage diode) D1. In other words, the current supply circuit 120 is connected between the n-2 connection points (nodes) between n-1 diodes (the subsequent stage diodes) except for the first diode (the first stage diode) D1. With respect to each of n-2 connection points, for example, one rectifier element is provided.

The n-2 rectifier elements D01, D02, . . . , and D0n-2 are diodes having a forward voltage Vf0, for example.

A first comparator COMP1 and a second transistor M2 are provided between the n-1 rectifier elements D0 and the power supply voltage Vcc. In the example illustrated in FIG. 5, one second transistor M2 is provided, and the currents flowing through n-1 rectifier elements D0 are collectively controlled. However, the number of second switches 124 provided in the current supply circuit 120 may not be one, and a plurality of second transistors M2, which are examples of the second switch 124, may also be provided to share and control the current flowing through the rectifier elements D01, D02, . . . , and D0n-2.

Since one or more rectifier elements D0 of the current supply circuit 120 are provided, n≥3. That is, the charge pump circuit includes three or more diodes and three or more capacitors.

The switching circuit 140 includes 2(n-1) switches S1a, S1b, . . . , and Sn-1b as the third switch 144. Although the illustration of the controller 142 is omitted, for example, a clock input connected to 2(n-1) switches S1a, S1b, . . . Sn-1b may be further provided.

Switches S1a and S1b are connected to the first capacitor C1. The state in which the switch S1a is ON and the switch S1b is OFF and the state in which the switch S1a is OFF and the switch S1b is ON are repeated. Switches S2a and S2b are connected to the second capacitor C2. The state in which the switch S2a is ON and the switch S2b is OFF and the state in which the switch S2a is OFF and the switch S2b is ON are repeated. Similarly, switches Sn-1a and Sn-1b are connected to the (n-1)th capacitor Cn-1. The state in which the switch Sn-1a is ON and the switch Sn-1b is OFF and the state in which the switch Sn-1a is OFF and the switch Sn-1b is ON are repeated.

When the switch S1a is ON, the switch S2b is ON, the switch S3a is ON, the switch S4b is ON, . . . , and the odd-numbered switches followed by “a” are ON and the even-numbered switches followed by “b” are ON. On the contrary, when the switch S1a is OFF, the odd-numbered switches followed by “b” are ON, and the even-numbered switches followed by “a” are ON. The switches S1a, S2a, . . . , Sn-1a are, for example, n-channel type MOSFETS, and the switches S1b, S2b, . . . , Sn-1b are, for example, p-channel type MOSFETS. The switches S1a, S2a, . . . , Sn-1a are, for example, p-channel type MOSFETS, and the switches S1b, S2b, . . . , Sn-1b are, for example, n-channel type MOSFETS.

The switch is, for example, a transistor. The switching circuit 140 further includes a clock input, and a clock may be input to each transistor. The even-numbered switches S2a, S2b, S4a, S4b, . . . receive inverted signals for odd-numbered switches S1a, S1b, S3a, S3b, . . . . The on and off of the plurality of switches is controlled as described above as an example.

Next, the operation of the voltage conversion circuit 300 will be described.

The boost operation by the first capacitor C1, the second capacitor C2, and the switches S1a, S1b, S2a, S2b, . . . is the same as the first embodiment.

In the first embodiment, a voltage of 3(Vcc−Vf) is obtained using the cathode voltage of the third diode D3 as the output voltage Vout. On the other hand, in the present embodiment, the cathode voltage of the third diode D3 is further boosted to 4Vcc−3Vf by switching between switches S3a and S3b. Therefore, the cathode voltage of a fourth diode D4 (not illustrated) is 4(Vcc−Vf).

In this way, boosting is performed according to the number of diodes, and n×(Vcc−Vf) is obtained as the cathode voltage of the n-th diode Dn. In other words, the voltage conversion circuit 300 according to the present embodiment boosts the power supply voltage Vcc to the output voltage Vout=n(Vcc−Vf) by using n diodes and n capacitors.

With the voltage conversion circuit 300 according to the present embodiment, it is generally possible to reduce voltage fluctuations in the n-stage charge pump circuit, prevent the generation of a negative voltage, and resume the boost operation quickly.

FIG. 5 illustrates a current path CP (CP1, CP2, . . . , and CPn-2). It should be noted that the current paths CP1, CP3, CP4 . . . , and CPn-3 are omitted from the illustration. When a current flows through the current path CP while the first transistor M1 of the current limit circuit 110 is in the off state, there is a risk that a negative charge may be charged in the first electrode of the capacitor.

With respect to the current path CP1 (current path via the second diode D2 as illustrated in FIG. 6), as in the first embodiment, the voltage of the cathode of the second diode D2 connected to the power supply voltage Vcc via the rectifier element D01 is maintained at or above a predetermined value, thereby reducing the flow of current through the current path CP1. This prevents a negative charge from being charged in the first electrode of the first capacitor C1.

Next, referring again to FIG. 5, with respect to the current path CP2, the voltage of the cathode of the third diode D3, to which the power supply voltage Vcc is connected via the rectifier element D02 of the current supply circuit 120, is maintained at or above a predetermined voltage. This prevents a current from flowing through the current path CP2, thereby preventing a negative charge from being charged in the first electrode of the second capacitor C2.

Similarly, with respect to the (n-2)th current path CPn-2, the voltage of the cathode of the (n-1)th diode Dn-1, to which the power supply voltage Vcc is connected via the rectifier element D0n-2 of the current supply circuit 120, is maintained at or above a predetermined voltage. This prevents a current from flowing through the current path CPn, thereby preventing a negative charge from being charged in the first electrode of the (n-2)th capacitor Cn-2.

Thus, a current is prevented from flowing through the current paths CP1, CP2, . . . , and CPn, thereby preventing a negative charge from being charged in the first electrodes of the capacitors C1, C2, . . . , and Cn-2. Generally, the generation of negative voltage is reduced in a charge pump circuit having a plurality of capacitors.

According to the semiconductor device of at least one of the first to third embodiments described above, the switching circuit 140 can continue the operation and resume the boost operation of the charge pump circuit 130 quickly. Furthermore, it is possible to reduce voltage fluctuations in the charge pump circuit 130, specifically the generation of a negative voltage, and improve reliability.

The switches described above may include transistors of IGBT, SiN, GaN, or the like, without being limited to MOSFETs.

With reference to specific examples, embodiments have been described above. However, the embodiments are not limited to these specific examples. That is, designs which a person skilled in the art appropriately modifies from these specific examples are also included within the scope of the embodiments as long as they have the features of the embodiments. Elements of each of the above-described specific examples, as well as their arrangement, materials, conditions, shapes, sizes, or the like are not limited to those exemplified, and can be modified as appropriate.

Furthermore, the elements of each of the above-described embodiments can be combined to the extent technically possible, and combinations of these are also included within the scope of the embodiments as long as they include the features of the embodiments. In addition, within the scope of the concept of the embodiments, a person skilled in the art may think of various modifications and alterations, and it is understood that these modifications and alterations also fall within the scope of the embodiments.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A voltage conversion circuit comprising:
a current limit circuit having a first switch;
a charge pump circuit having a first stage diode connected to the current limit circuit, and two or more subsequent stage diodes connected in series to each other and to the first stage diode; and
a current supply circuit having a rectifier connected to a node between the subsequent stage diodes of the charge pump circuit, wherein a forward direction of the rectifier extends through the rectifier to the node.

2. The voltage conversion circuit according to claim 1, wherein
the charge pump circuit further includes a plurality of capacitors connected to the first stage diode and the subsequent stage diodes, respectively.

3. The voltage conversion circuit according to claim 2, further comprising:
a switching circuit that is connected to the charge pump circuit and supplies a time-varying voltage to the charge pump circuit.

4. The voltage conversion circuit according to claim 3, wherein
the switching circuit includes a plurality of switches and a controller that periodically switches connection state of the switches.

5. The voltage conversion circuit according to claim 1, wherein
the current supply circuit further includes a second switch, where the rectifier is connected in series between the second switch and the charge pump circuit.

6. The voltage conversion circuit according to claim 5, wherein
the current supply circuit further includes a voltage detection circuit having an input to which an output voltage of the charge pump circuit is supplied, and
an output of the voltage detection circuit is connected to the second switch.

7. The voltage conversion circuit according to claim 1, wherein
a forward voltage Vf0 of the rectifier and a forward voltage Vf of one of the diodes that has a cathode connected to the rectifier satisfy a relationship: Vf0≤Vf.

8. The voltage conversion circuit according to claim 1, wherein
the rectifier is a diode with same rectification properties as one of the diodes that has a cathode connected to the rectifier.

9. The voltage conversion circuit according to claim 1, wherein
the first switch is a transistor, and
the current limit circuit further includes a first resistor and a first amplifier having inputs respectively connected to opposite ends of the first resistor and an output connected to a gate terminal of the transistor.

10. The voltage conversion circuit according to claim 1, wherein the rectifier has a variable forward voltage, said voltage conversion circuit further comprising:
a rectification control circuit that controls a magnitude of the forward voltage of the rectifier.

11. A semiconductor circuit comprising:
the voltage conversion circuit according to claim 1; and
a drive circuit which receives a voltage converted by the voltage conversion circuit as input.

12. A voltage conversion circuit comprising:
a charge pump circuit configured to convert an input voltage to an output voltage;
a current limit circuit configured to switch a connection state between the input voltage and the charge pump circuit; and
a current supply circuit that is connected to the charge pump circuit, and configured to perform a rectification function between a power supply having the input voltage and the charge pump circuit, and to maintain a voltage in the charge pump circuit at or above Vcc−Vf, where Vcc is the input voltage and Vf is a forward voltage provide by the rectification function.

13. A motor drive module comprising:
the voltage conversion circuit according to claim 12; and
a drive circuit which receives a voltage converted by the voltage conversion circuit as input, and outputs a voltage to drive a motor.
